(19) United States
(12) Patent Application Publication
(10) Pub. No.: US 2014/0025683 A1
(43) Pub. Date: Jan. 23, 2014

(54) METHODS AND APPARATUS FOR MANAGING COMMUNITY-UPDATEABLE DATA

(71) Applicant: Salesforce.com, Inc., San Francisco, CA (US)

(72) Inventors: Craig Howland, Fremont, CA (US); Stanislav Georgiev, Sunnyvale, CA (US); Feng Meng, Foster City, CA (US); George Vitchev, Santa Clara, CA (US); Zandro Luis Gonzalez, San Mateo, CA (US); Matthew Fuchs, Los Gatos, CA (US); Arun Jagota, Sunnyvale, CA (US)

(21) Appl. No.: 13/945,758

(22) Filed: Jul. 18, 2013

Related U.S. Application Data
(60) Provisional application No. 61/672,901, filed on Jul. 18, 2012.

(51) Int. Cl. G06F 17/30

(52) U.S. Cl. CPC G06F 17/30598
USPC 707/740; 707/736

(57) ABSTRACT

A method of managing crowdsourced data includes storing contact information regarding a plurality of contacts within a community-updateable repository accessible by a plurality of users, receiving a plurality of discrepancy reports associated with a selected contact of the plurality of contacts, extracting fact data regarding the selected contact from the plurality of discrepancy reports, determining an action to be taken based on the fact data and a fact model applied to the fact data, and performing the action to modify the community-updateable repository.

### CROSS-REFERENCE TO RELATED APPLICATION(S)

This application claims the benefit of U.S. provisional patent application Ser. No. 61/672,901, filed Jul. 18, 2012, the entire contents of which are incorporated by reference herein.

### TECHNICAL FIELD

Embodiments of the subject matter described herein relate generally to computer systems. More particularly, embodiments of the subject matter relate to methods and systems for managing data, such as community-updateable contact information.

### BACKGROUND

A continuing challenge for data service providers is scalability. As data repositories become larger and larger, it is important that the systems and methods used to manage those repositories be capable of accommodating significant data growth over time.

Such challenges are particularly significant in the case of community-updateable or “crowdsourced” data repositories. Since crowdsourced repositories are populated by the users themselves, it is not unusual for the crowdsourced data to contain inaccuracies, missing information, or other such errors. In the case of community-updateable contact information, for example, the data might include e-mail addresses that are invalid or otherwise unusable. Maintaining the accuracy of such data in a scalable manner presents significant challenges. For example, the size and volume of e-mail “bounce reports” associated with massive repositories can be difficult to process in a timely and efficient manner.

Accordingly, there is a need for improved systems and methods for managing community-updateable data.

### BRIEF DESCRIPTION OF THE DRAWINGS

A more complete understanding of the subject matter may be derived by referring to the detailed description and claims when considered in conjunction with the following figures, wherein like reference numbers refer to similar elements throughout the figures.

FIGS. 1A and 1B together present a conceptual block diagram of a system in accordance with one embodiment.

FIG. 2 illustrates a fact handling system in accordance with one embodiment.

FIG. 3 is a flow-chart depicting a method in accordance with one embodiment.

FIG. 4 is a block diagram of an exemplary multi-tenant system suitable for use in connection with the various embodiments described herein.

FIG. 5 is a flow-chart depicting a method in accordance with one embodiment.

### DETAILED DESCRIPTION

Embodiments of the subject matter described herein generally relate to systems and methods for maintaining the accuracy of, and otherwise managing, crowdsourced data such as a repository of community-updateable contact information.

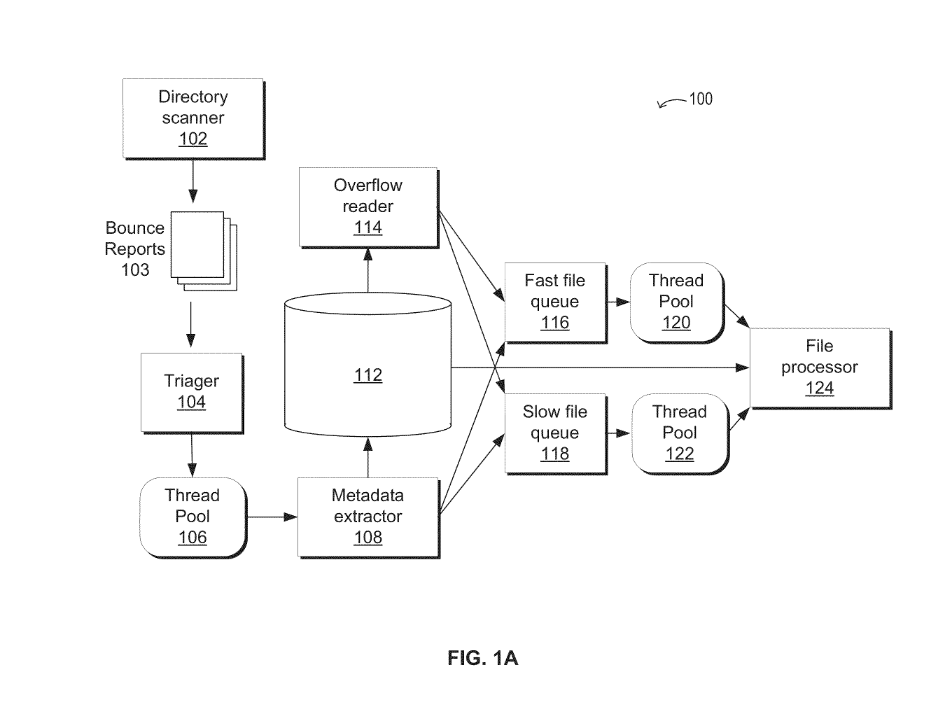

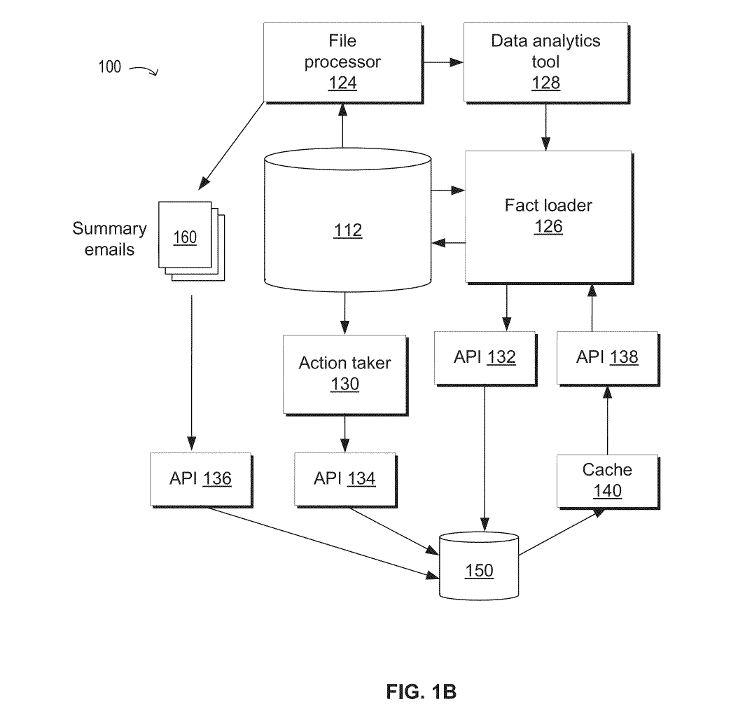

FIGS. 1A and 1B together depict a conceptual block diagram/flow diagram of a data management system (or simply “system”) 100 in accordance with one embodiment. It will be appreciated that the illustrated architecture is merely presented as an example, and that the embodiments are not limited to the functional modules presented therein. For example, some alternate embodiments might dispense with one or more of the illustrated modules, and other embodiments might include additional function modules.

In general, data management system 100 is directed at maintaining, in a scalable manner, the accuracy of a crowdsourced data repository (or simply “repository”) 150 (illustrated in FIG. 1B) based in part on any number of discrepancy reports or “bounce reports” 103 (FIG. 1A) associated with that crowdsourced data. In this regard, the phrase “crowdsourced data repository” as used herein refers to a shared pool of data to which multiple parties may contribute (e.g., users of multi-tenant system, as will be discussed in detail below). In one example, repository 150 comprises a community-updateable list of contact information and other business data (e.g., e-mail addresses, contact names, etc.). One example of such a system is the Data.com® system provided by Salesforce.com. It will be appreciated, however, that this example is used without loss of generality, and that the embodiments described herein may be used in conjunction with any type of crowdsourced data—particularly crowdsourced data that is subject to inaccuracies or might become outdated over time. The term “bounce report” is used herein without lack of generality to refer to a particular type of discrepancy report that would typically be associated with e-mail addresses. However, other types of contact-related discrepancy reports (e.g., relating to phone numbers, title (Mr., Mrs., etc.), and the like) may also be used in connection with the illustrated system.

Referring now to FIG. 1A, system 100 includes a directory scanner 102 configured to scan (i.e., read and evaluate) various input directories within the system (e.g., one or more databases, such as database 112) for unprocessed “bounce reports” 103. As is known in the art, a bounce report—also referred to as a Non-Delivery Report/Receipt (NDR), a failed Delivery Status Notification (DSN) message, or a Non-Delivery Notification (NDN)—comprises an automated electronic mail message from a mail system (not illustrated) informing the sender that a delivery problem has occurred. Directory scanner 102 may scan a number of directories to identify such unprocessed bounce reports. In one embodiment, for example, directory scanner 102 inspects five different folders: an “input” folder in which bounce reports are first deposited, a “processing” folder containing bounce reports being processed, a “delay1” folder containing bounce reports that failed to be processed (e.g., due to a temporary error, such as a network outage), a “delay2” folder containing bounce reports that failed to be processed twice, and a “delay3” folder containing bounce reports that failed to be processed three times. Any number of other such folders may be scanned.

The unprocessed bounce reports (or “bounce report files”) 103 are provided, through triager 104 and thread pool 106, to metadata extractor 108. In general, thread pool 106 provides a number of computational threads so that they are available to perform various tasks, which may be organized as a queue. Triager 104 (e.g., a Quartz scheduler or other enterprise job scheduler) manages those threads for use by metadata extractor 108.

Metadata extractor 108 is configured to extract file metadata (e.g., e-mail metadata) from bounce reports 103. In one embodiment, each bounce report 103 is a text file including a number of lines, each corresponding to a particular bounce event, and metadata extractor 108 is configured to count the number of lines in each bounce report 103 to determine its size. Other measures of file size may also be used. Metadata extractor 108 then stores the metadata as a file within database 112 and indicates that the status of that file as “new” The corresponding bounce reports are then placed within a “processing folder,” as mentioned above. Database 112 may be implemented using a variety of known database solutions, including, for example, Apache Hadoop™, Apache Hbase™, Cloudera®, HortonWorks, Apache Ambari, or the like. Such implementations are well known, and need not be discussed in detail herein.

Depending upon the size of bounce report file (as determined, for example, by its number of lines), that file is provided to one of two queues: fast file queue 116 (with corresponding thread pool 120) or slow file queue 118 (with corresponding thread pool 122). In one embodiment, files with a size greater than a predetermined threshold (e.g., about 1000 lines) are provided to slow file queue 118, while all other files are provided to fast file queue 116. Thus, relatively small (e.g., user-submitted) files are prioritized over relatively large files, such as bounce report files provided by a corporate entity or other large organization.

An additional overflow reader 114 may also provided and is configured to periodically load unprocessed bounce report files from database 112 and provide them to fast file queue 116 or slow file queue 118 in accordance with criteria as set forth above in connection with metadata extractor 108.

File processor 124, in accordance with thread pools 120 and 122, acquires the bounce reports from repository 112 and provides them to a data analytics tool 128. In one embodiment, for example, data analytics tool 128 performs an Apache Hadoop job, as is known in the art, that extracts relevant information from the bounce reports files 103 and provides that information to fact loader 126.

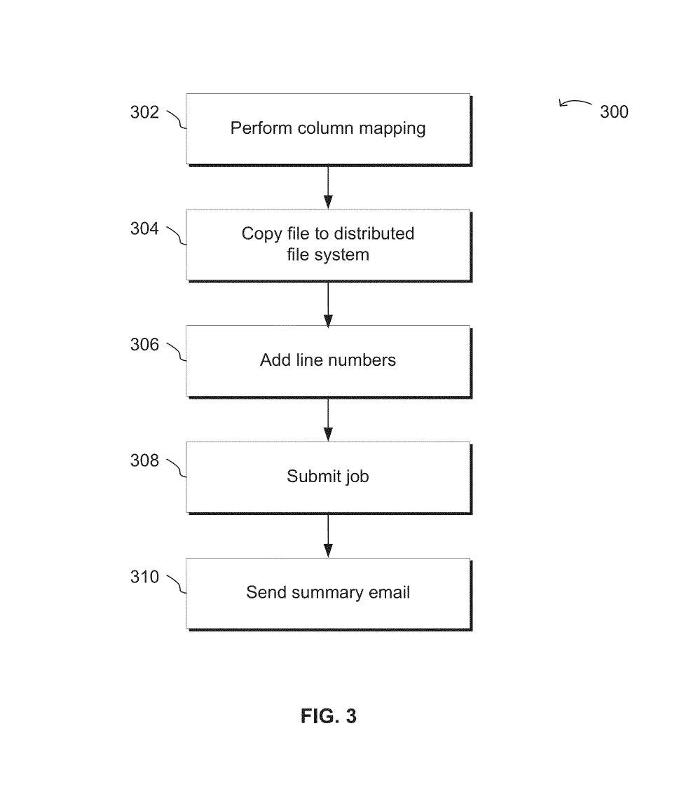

File processor 124 may also configured to send summary e-mails 160 to repository 150 (via API 136) or a stand alone e-mail processing system (not illustrated) for forwarding to the user, or “owner” of the associated bounce reports 103. This provides the user with follow-up information regarding how the submitted bounce reports were (or will be) categorized by the system (e.g., hard bounce, soft bounce, duplicate, etc.). In that regard, referring briefly to the flowchart shown in FIG. 3, a method 300 that might be performed by file processor 124 begins with performing column mapping (step 302) on bounce reports 103 (which may have a variety of formats) to determine which columns within each report correspond to particular data types. Example data types include, without limitation, date of bounce event, e-mail address of interest, bounce message, and the like. This column mapping might be performed in a variety of ways known in the art, e.g., through standard pattern matching techniques.

After column mapping, the processor then copies the bounce report (or “file”) to a distributed file system (step 304). That is, the file is partitioned into many smaller files for parallel processing in parallel threads. In order to facilitate this process, line numbers (associated with the original bounce report) are added to each corresponding line in each of the distributed files (step 306). In this way, the original line numbering may be reconstructed (e.g., after map/reduce).

Finally, the job is then submitted to data analytics tool 128 (step 308). After data analytics tool 128 has finished, a summary e-mail or other summary file (containing a summary of the results of data analytics tool 128) is sent to repository 150 for forwarding to the associated user or enterprise.

Referring again to FIGS. 1A and 1B, fact processor 126, which receives the result of data analytics tool 128 and is configured to share information with database 112, is configured to perform file mapping and file reduction (i.e., “map/reduce”) with respect to the bounce report files. In connection with file mapping, fact processor 126 extracts data such as e-mail addresses from the bounce report files. In one embodiment, the extracted e-mail address then becomes the key used for the reduce job. In some embodiments, for example, each line of the bounce report file includes a header followed by a single e-mail address followed by a bounce code. An example of such a bounce report is provided below for reference (with three e-mail addresses illustrated):

USER_ID, 12345
VENDOR, ConstantContact
CASE_NUM, 1232
DATE, 20130622
E-mail, Bounce Code
len.grodoski@sun.com 4.4.1
dpote@ifllaw.com, 5.5.3
jcolano@geosoftusa.com, bad e-mail from mailtester

In connection with its reducer functionality, fact processor 126 communicates with data analytics tool 128 and database 112 to load all known historical facts about the particular e-mail address being analyzed. As used herein, the term “fact” is a term of art that refers to an “assertion” or “vote” regarding a particular e-mail address or other contact information. For example, one bounce report might assert that a particular e-mail address is a “hard bounce”, while another bounce report (from the same or different user) might assert that that same e-mail address is “spam.” Each of these assertions constitute “facts” that are reconciled by the system. After receiving the relevant facts, fact processor 126 determines which action, if any, should be taken with respect to the contact information. For example, certain e-mail addresses may be removed from repository 150 (e.g., sent to a “graveyard”), while others might be revived from the graveyard. The set of actions to be taken are suitably stored or persisted within database 112.

Action taker 130 periodically pulls unprocessed actions from database 112 and (through API 134), and implements that action within respect to repository 150. Two application programming interfaces are provided: API 132 and API 138. API 132 provides an interface to database repository, while API provides an interface to cache 140, which is communicatively coupled to repository 150.

Thus, the general structure of system 100 as outlined above, with its multi-threading capabilities, prioritization of smaller files, and advanced fact handling, provide a scalable method of managing large volumes of bounce reports relating to the ever-growing crowd-sourced repository 150.

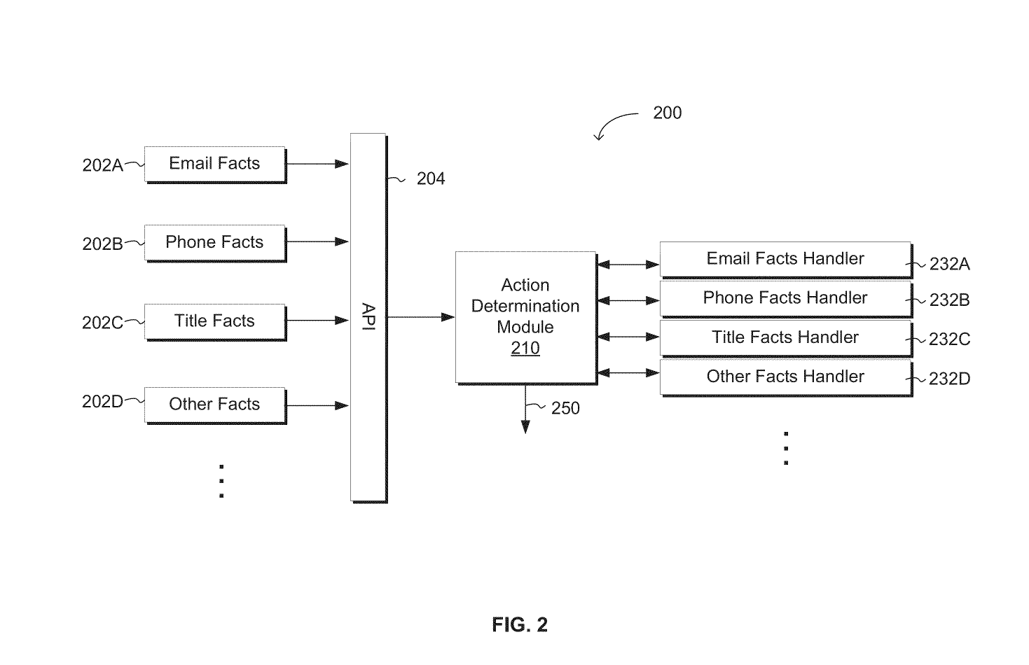

Referring more particularly to fact processor 126, FIG. 2 is a conceptual block diagram illustrating a fact handling system 200 in accordance with one embodiment, which may be implemented within fact processor 126. As shown, system 200 includes an action determination module 210 coupled to e-mail facts handler 232A, phone facts handler 232B, title facts handler 232C, and other facts handler 232D. Module 210 is also coupled, through API 204, to e-mail facts 202A, phone facts 202B, title facts 202C, and other facts 202D. As will be appreciated fact handlers 232 as well as their respective facts 202 generally relate to contact information regarding contacts stored within repository 112.

As noted above, a “fact” in this context represents an assertion regarding a one or more pieces of contact information, e.g., e-mail addresses, phone numbers, title (Mr. or Mrs.), and the like. For example, e-mail facts 202A may include information indicating that a particular e-mail address has been categorized as a “hard bounce” (as determined and recorded by metadata extractor 108).

Module 210 is configured to analyze received facts 202 to determine whether and to what extent the contact information is accurate. Module 210 then determines the appropriate action 250 to take using the appropriate facts handler 232. For example, e-mail facts handler 232A would be used to determine the action to be taken when an e-mail address is found to be “spam.”

In one embodiment, module 210 is configured to apply a fact model to the acquired facts to determine the accuracy or assumed “status” of the contact information. This fact model may, for example, be a model developed via supervised or unsupervised machine learning algorithms applied to historical data (e.g., past data regarding known spam, hard bounces, or the like). In one embodiment the fact model applies weighting to the acquired facts based, for example, on the trustability of the user that submitted the bounce report. That is, module 210 might attach greater weight to bounce reports submitted by an individual end-user having a high reliability than to a large enterprise known to submit large, often inaccurate bounce reports. Module 210 might also attach greater weight to certain e-mail services over others (e.g., e-mail systems known to have greater reliability). In accordance with one embodiment, fact handling system 200 can be easily expanded by “plugging in” additional facts handlers 232, thereby allowing the system to accommodate any additional types of facts and data to be used in the future.

Referring now to FIG. 6 in conjunction with FIGS. 1A and 1B, an exemplary method of managing a community-updateable repository will now be described. Initially, in step 602, contact information regarding a plurality of contacts are stored within a community-updateable repository accessible by a plurality of users (e.g., repository 150). Next, in step 604, a plurality of discrepancy reports (e.g., bounce reports 130) are received, each associated with a selected contact of the plurality of contacts. Fact data is then extracted from the plurality of discrepancy reports (step 606). Based on the fact data and a fact model applied to the fact data, the system determines the action to be taken (608) (e.g., “graveyard” the contact information, designate as “spam”, etc.). Finally, the system performs the action to appropriately modify the community-updateable repository (610).

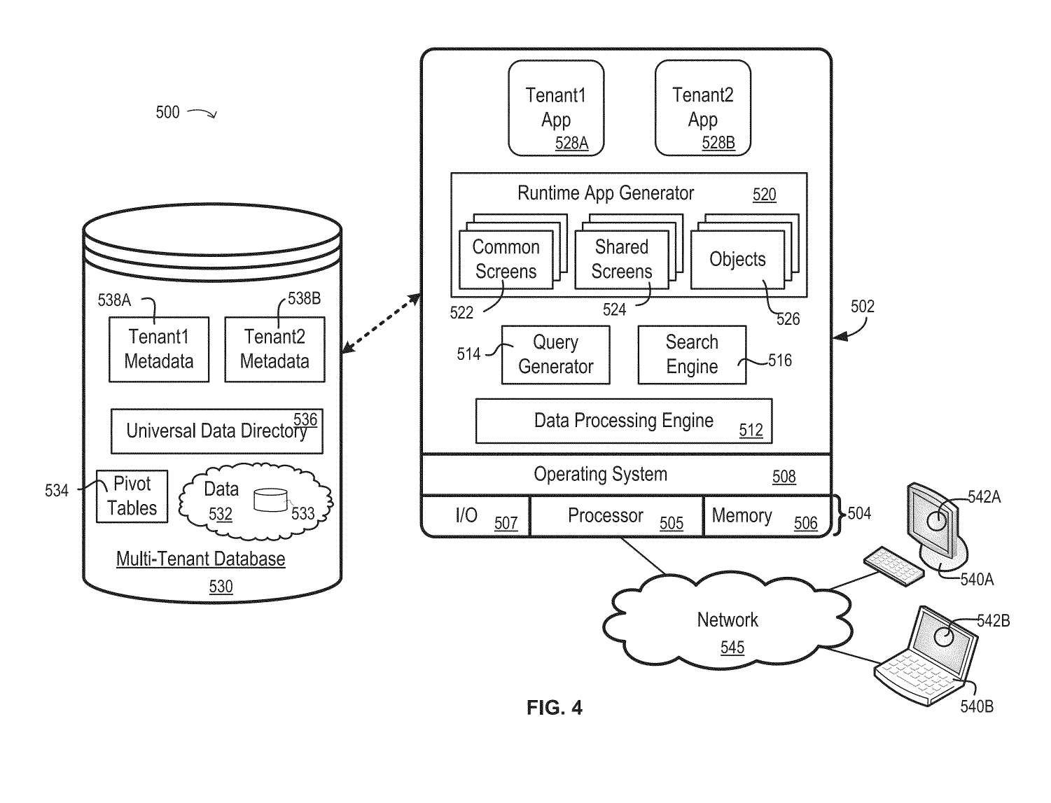

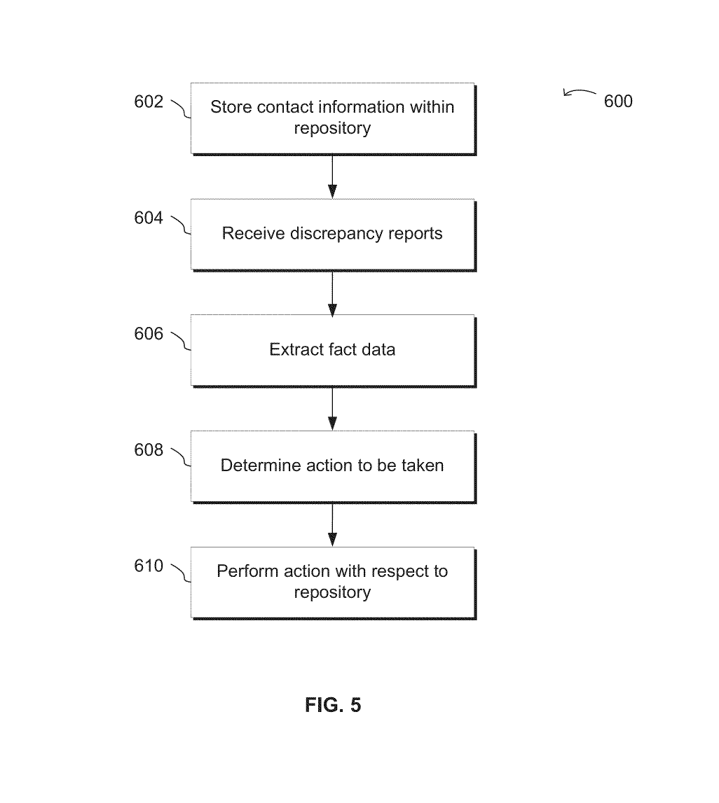

The subject matter described above may be implemented in the context of a wide range of database environments. In one embodiment, for example, the crowdsourced data may be stored within a “multi-tenant” database system. In this regard, FIG. 4 illustrates an exemplary multi-tenant system 500 that includes a server 502 that dynamically creates and supports virtual applications 528 based upon data 532 from a common database 530 that is shared between multiple tenants, alternatively referred to herein as a multi-tenant database. Data 532 includes the crowdsourced data 533 (corresponding to repository 150 in FIGS. 1A and 1B). As mentioned above, the phrase “crowdsourced data repository” as used herein refers to a shared pool of data to which multiple parties may contribute (e.g., users of multi-tenant system 500).

With continued reference to the multi-tenant system of FIG. 4, data and services generated by the virtual applications 528 are provided via a network 545 to any number of client devices 540, as desired. Each virtual application 528 is suitably generated at run-time (or on-demand) using a common application platform 510 that securely provides access to the data 532 in the database 530 for each of the various tenants subscribing to the multi-tenant system 500. In accordance with one non-limiting example, the multi-tenant system 500 is implemented in the form of an on-demand multi-tenant customer relationship management (CRM) system that can support any number of authenticated users of multiple tenants.

As used herein, a “tenant” or an “organization” should be understood as referring to a group of one or more users that shares access to common subset of the data within the multi-tenant database 530. In this regard, each tenant includes one or more users associated with, assigned to, or otherwise belonging to that respective tenant. Stated another way, each respective user within the multi-tenant system 500 is associated with, assigned to, or otherwise belongs to a particular tenant of the plurality of tenants supported by the multi-tenant system 500. Tenants may represent customers, customer departments, business or legal organizations, and/or any other entities that maintain data for particular sets of users within the multi-tenant system 500. Although multiple tenants may share access to the server 502 and the database 530, the particular data and services provided from the server 502 to each tenant can be securely isolated from those provided to other tenants. The multi-tenant architecture therefore allows different sets of users to share functionality and hardware resources without necessarily sharing any of the data 532 belonging to or otherwise associated with other tenants.

The multi-tenant database 530 is any sort of repository or other data storage system capable of storing and managing the data 532 associated with any number of tenants. The database 530 may be implemented using any type of conventional database server hardware. In various embodiments, the database 530 shares processing hardware 504 with the server 502. In other embodiments, the database 530 is implemented using separate physical and/or virtual database server hardware that communicates with the server 502 to perform the various functions described herein. In an exemplary embodiment, the database 530 includes a database management system or other equivalent software capable of determining an optimal query plan for retrieving and providing a particular subset of the data 532 to an instance of virtual application 528 in response to a query initiated or otherwise provided by a virtual application 528. The multi-tenant database 530 may alternatively be referred to herein as an on-demand database, in that the multi-tenant database 530 provides (or is available to provide) data at run-time to on-demand virtual applications 528 generated by the application platform 310.

In practice, the data 532 may be organized and formatted in any manner to support the application platform 510. In various embodiments, the data 532 is suitably organized into a relatively small number of large data tables to maintain a semi-amorphous “heap”-type format. The data 532 can then be organized as needed for a particular virtual application 528. In various embodiments, conventional data relationships are established using any number of pivot tables 534 that establish indexing, uniqueness, relationships between entities, and/or other aspects of conventional database organization as desired. Further data manipulation and report formatting is generally performed at run-time using a variety of metadata constructs. Metadata within a universal data directory (UDD) 536, for example, can be used to describe any number of forms, reports, workflows, user access privileges, business logic and other constructs that are common to multiple tenants. Tenant-specific formatting, functions and other constructs may be maintained as tenant-specific metadata 538 for each tenant, as desired. Rather than forcing the data 532 into an inflexible global structure that is common to all tenants and applications, the database 530 is organized to be relatively amorphous, with the pivot tables 534 and the metadata 538 providing additional structure on an as-needed basis. To that end, the application platform 510 suitably uses the pivot tables 134 and/or the metadata 538 to generate “virtual” components of the virtual applications 528 to logically obtain, process, and present the relatively amorphous data 532 from the database 530.

The server 502 is implemented using one or more actual and/or virtual computing systems that collectively provide the dynamic application platform 510 for generating the virtual applications 528. For example, the server 502 may be implemented using a cluster of actual and/or virtual servers operating in conjunction with each other, typically in association with conventional network communications, cluster management, load balancing and other features as appropriate. The server 502 operates with any sort of conventional processing hardware 504, such as a processor 505, memory 506, input/output features 507 and the like. The input/output features 507 generally represent the interface(s) to networks (e.g., to the network 545, or any other local area, wide area or other network), mass storage, display devices, data entry devices and/or the like. The processor 505 may be implemented using any suitable processing system, such as one or more processors, controllers, microprocessors, microcontrollers, processing cores and/or other computing resources spread across any number of distributed or integrated systems, including any number of “cloud-based” or other virtual systems. The memory 506 represents any non-transitory short or long term storage or other computer-readable media capable of storing programming instructions for execution on the processor 505, including any sort of random access memory (RAM), read only memory (ROM), flash memory, magnetic or optical mass storage, and/or the like. The computer-executable programming instructions, when read and executed by the server 502 and/or processor 105, cause the server 502 and/or processor 105 to create, generate, or otherwise facilitate the application platform 510 and/or virtual applications 528 and perform one or more additional tasks, operations, functions, and/or processes described herein. It should be noted that the memory 506 represents one suitable implementation of such computer-readable media, and alternatively or additionally, the server 502 could receive and cooperate with external computer-readable media that is realized as a portable or mobile component or application platform, e.g., a portable hard drive, a USB flash drive, an optical disc, or the like.

The application platform 510 is any sort of software application or other data processing engine that generates the virtual applications 528 that provide data and/or services to the client devices 540. In a typical embodiment, the application platform 510 gains access to processing resources, communications interfaces and other features of the processing hardware 504 using any sort of conventional or proprietary operating system 108. The virtual applications 528 are typically generated at run-time in response to input received from the client devices 540. For the illustrated embodiment, the application platform 510 includes a bulk data processing engine 512, a query generator 514, a search engine 516 that provides text indexing and other search functionality, and a runtime application generator 520. Each of these features may be implemented as a separate process or other module, and many equivalent embodiments could include different and/or additional features, components or other modules as desired.

The runtime application generator 520 dynamically builds and executes the virtual applications 528 in response to specific requests received from the client devices 540. The virtual applications 528 are typically constructed in accordance with the tenant-specific metadata 538, which describes the particular tables, reports, interfaces and/or other features of the particular application 528. In various embodiments, each virtual application 528 generates dynamic web content that can be served to a browser or other client program 542 associated with its client device 540, as appropriate.

The runtime application generator 520 suitably interacts with the query generator 514 to efficiently obtain multi-tenant data 532 from the database 530 as needed in response to input queries initiated or otherwise provided by users of the client devices 540. In a typical embodiment, the query generator 514 considers the identity of the user requesting a particular function (along with the user's associated tenant), and then builds and executes queries to the database 530 using system-wide metadata 536, tenant specific metadata 538, pivot tables 534, and/or any other available resources. The query generator 514 in this example therefore maintains security of the common database 530 by ensuring that queries are consistent with access privileges granted to the user and/or tenant that initiated the request. In this manner, the query generator 514 suitably obtains requested subsets of data 532 accessible to a user and/or tenant from the database 530 as needed to populate the tables, reports or other features of the particular virtual application 528 for that user and/or tenant.

Still referring to FIG. 4, the data processing engine 512 performs bulk processing operations on the data 532 such as uploads or downloads, updates, online transaction processing, and/or the like. In many embodiments, less urgent bulk processing of the data 532 can be scheduled to occur as processing resources become available, thereby giving priority to more urgent data processing by the query generator 514, the search engine 516, the virtual applications 528, etc.

In exemplary embodiments, the application platform 510 is utilized to create and/or generate data-driven virtual applications 528 for the tenants that they support. Such virtual applications 528 may make use of interface features such as custom (or tenant-specific) screens 524, standard (or universal) screens 522 or the like. Any number of custom and/or standard objects 526 may also be available for integration into tenant-developed virtual applications 528. As used herein, “custom” should be understood as meaning that a respective object or application is tenant-specific (e.g., only available to users associated with a particular tenant in the multi-tenant system) or user-specific (e.g., only available to a particular subset of users within the multi-tenant system), whereas “standard” or “universal” applications or objects are available across multiple tenants in the multi-tenant system. The data 532 associated with each virtual application 528 is provided to the database 530, as appropriate, and stored until it is requested or is otherwise needed, along with the metadata 538 that describes the particular features (e.g., reports, tables, functions, objects, fields, formulas, code, etc.) of that particular virtual application 528. For example, a virtual application 528 may include a number of objects 126 accessible to a tenant, wherein for each object 526 accessible to the tenant, information pertaining to its object type along with values for various fields associated with that respective object type are maintained as metadata 538 in the database 530. In this regard, the object type defines the structure (e.g., the formatting, functions and other constructs) of each respective object 526 and the various fields associated therewith.

With continued reference to FIG. 4, the data and services provided by the server 502 can be retrieved using any sort of personal computer, mobile telephone, tablet or other network-enabled client device 540 on the network 545. In an exemplary embodiment, the client device 340 includes a display device, such as a monitor, screen, or another conventional electronic display capable of graphically presenting data and/or information retrieved from the multi-tenant database 530. Typically, the user operates a conventional browser application or other client program 542 executed by the client device 540 to contact the server 502 via the network 545 using a networking protocol, such as the hypertext transport protocol (HTTP) or the like. The user typically authenticates his or her identity to the server 502 to obtain a session identifier (“SessionID”) that identifies the user in subsequent communications with the server 502. When the identified user requests access to a virtual application 528, the runtime application generator 520 suitably creates the application at run time based upon the metadata 538, as appropriate. As noted above, the virtual application 528 may contain Java, ActiveX, or other content that can be presented using conventional client software running on the client device 540; other embodiments may simply provide dynamic web or other content that can be presented and viewed by the user, as desired.

The foregoing description is merely illustrative in nature and is not intended to limit the embodiments of the subject matter or the application and uses of such embodiments. Furthermore, there is no intention to be bound by any expressed or implied theory presented in the technical field, background, or the detailed description. As used herein, the word “exemplary” means “serving as an example, instance, or illustration.” Any implementation described herein as exemplary is not necessarily to be construed as preferred or advantageous over other implementations, and the exemplary embodiments described herein are not intended to limit the scope or applicability of the subject matter in any way.

For the sake of brevity, conventional techniques related to databases, application programming interfaces (APIs), user interfaces, and other functional aspects of the systems (and the individual operating components of the systems) may not be described in detail herein. In addition, those skilled in the art will appreciate that embodiments may be practiced in conjunction with any number of system and/or network architectures, data transmission protocols, and device configurations, and that the system described herein is merely one suitable example. Furthermore, certain terminology may be used herein for the purpose of reference only, and thus is not intended to be limiting. For example, the terms “first”, “second” and other such numerical terms do not imply a sequence or order unless clearly indicated by the context.

Embodiments of the subject matter may be described herein in terms of functional and/or logical block components, and with reference to symbolic representations of operations, processing tasks, and functions that may be performed by various computing components or devices. Such operations, tasks, and functions are sometimes referred to as being computer-executed, computerized, software-implemented, or computer-implemented. In practice, one or more processing systems or devices can carry out the described operations, tasks, and functions by manipulating electrical signals representing data bits at accessible memory locations, as well as other processing of signals. The memory locations where data bits are maintained are physical locations that have particular electrical, magnetic, optical, or organic properties corresponding to the data bits. It should be appreciated that the various block components shown in the figures may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices. When implemented in software or firmware, various elements of the systems described herein are essentially the code segments or instructions that perform the various tasks. The program or code segments can be stored in a processor-readable medium or transmitted by a computer data signal embodied in a carrier wave over a transmission medium or communication path. The “processor-readable medium” or “machine-readable medium” may include any non-transitory medium that can store or transfer information. Examples of the processor-readable medium include an electronic circuit, a semiconductor memory device, a ROM, a flash memory, an erasable ROM (EROM), a floppy diskette, a CD-ROM, an optical disk, a hard disk, a fiber optic medium, a radio frequency (RF) link, or the like. The computer data signal may include any signal that can propagate over a transmission medium such as electronic network channels, optical fibers, air, electromagnetic paths, or RF links. The code segments may be downloaded via computer networks such as the Internet, an intranet, a LAN, or the like. In this regard, the subject matter described herein can be implemented in the context of any computer-implemented system and/or in connection with two or more separate and distinct computer-implemented systems that cooperate and communicate with one another. In one or more exemplary embodiments, the subject matter described herein is implemented in conjunction with a virtual customer relationship management (CRM) application in a multi-tenant environment.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application. Accordingly, details of the exemplary embodiments or other limitations described above should not be read into the claims absent a clear intention to the contrary.

What is claimed is:

1. A method for managing a community-updateable repository accessible by a plurality of users, the method comprising:
storing contact information regarding a plurality of contacts within the community-updateable repository;
receiving a plurality of discrepancy reports associated with a selected contact of the plurality of contacts;
extracting fact data regarding the selected contact from the plurality of discrepancy reports;
determining an action to be taken based on the fact data and a fact model applied to the fact data; and
performing the action to modify the community-updateable repository.

2. The method of claim 1, wherein the contact information includes a plurality of e-mail addresses, and the plurality of discrepancy reports comprise e-mail bounce reports.

3. The method of claim 2, further including:
determining the size of each of the e-mail bounce reports; and
categorizing each of the e-mail bounce reports as a first category when the size of the e-mail bounce report is above a predetermined threshold, and as a second category when the size of the e-mail bounce report is less than or equal to the predetermined threshold;
wherein determining the action to be taken includes processing the first category of e-mail bounce reports with a slow file queue, and processing the second category of e-mail bounce reports with a fast file queue.

4. The method of claim 1, wherein the community-updateable repository is stored within a multi-tenant database system.

5. The method of claim 1, wherein the fact model is a determined via machine learning applied to historical information regarding the community-updateable repository.

6. The method of claim 1, wherein the fact data comprises at least two categories of data.

7. The method of claim 1, further including sending a digital message regarding the action taken to a user associated with the discrepancy report.

8. A contact management system comprising:
a community-updateable repository accessible by a plurality of users and configured to store contact information regarding a plurality of contacts;
a directory scanner module configured to identify a plurality of discrepancy reports associated with a selected contact of the plurality of contacts;
a metadata extractor module configured to extract fact data regarding the selected contact from the plurality of discrepancy reports;
an action determination module configured to determine an action to be taken based on the fact data and a fact model applied to the fact data; and
an action taker module configured to perform the action to modify the community-updateable repository.

9. The contact management system of claim 8, wherein the contact information includes a plurality of e-mail addresses, and the plurality of discrepancy reports comprise e-mail bounce reports.

10. The contact management system of claim 9, wherein the action taker module is configured to process a first category of e-mail bounce reports with a slow file queue, and process a second category of e-mail bounce reports with a fast file queue, wherein the second category of e-mail bounce reports has a size greater than or equal to a predetermined threshold, and the first category of e-mail bounce reports has a size less the predetermined threshold.

11. The contact management system of claim 8, wherein the community-updateable repository is stored within a multi-tenant database system.

12. The contact management system of claim 8, wherein the fact model is a determined via machine learning applied to historical information regarding the community-updateable repository.

13. The contact management system of claim 8, wherein the fact data comprises at least two categories of data.

14. The contact management system of claim 13, wherein the at least two categories of data comprises e-mail data and phone number data.

15. A non-transitory computer-readable medium comprising computer-executable instructions that, when executed by a processing system, cause the processing system to:
store contact information regarding a plurality of contacts within a community-updateable repository accessible by a plurality of users;
receive a plurality of discrepancy reports associated with a selected contact of the plurality of contacts;
extract fact data regarding the selected contact from the plurality of discrepancy reports;
determine an action to be taken based on the fact data and a fact model applied to the fact data; and
perform the action to modify the community-updateable repository.

16. The non-transitory computer-readable medium of claim 15, wherein the contact information includes a plurality of e-mail addresses, and the plurality of discrepancy reports comprise e-mail bounce reports.

17. The non-transitory computer-readable medium of claim 15, wherein the computer-readable instructions cause the processing system to:
determine the size of each of the e-mail bounce reports; and
categorize each of the e-mail bounce reports as a first category when the size of the e-mail bounce report is above a predetermined threshold, and as a second category when the size of the e-mail bounce report is less than or equal to the predetermined threshold;
determine the action to be taken by processing the first category of e-mail bounce reports with a slow file queue, and processing the second category of e-mail bounce reports with a fast file queue.

18. The non-transitory computer-readable medium of claim 15, wherein the processing system is configured to store the community-updateable repository within a multi-tenant database system.

19. The non-transitory computer-readable medium of claim 15, wherein the fact model is a determined via machine learning applied to historical information regarding the community-updateable repository.

20. The non-transitory computer-readable medium of claim 15, wherein the fact data comprises at least two categories of data.
